(19) United States
(12) Patent Application Publication
(10) Pub. No.: US 2025/0136192 A1
(43) Pub. Date: May 1, 2025

(54) Vehicle Storage System

(71) Applicant: Nissan North America, Inc., Franklin, TN (US)

(72) Inventor: David Kovie, Livonia, MI (US)

(21) Appl. No.: 18/385,788

(22) Filed: Oct. 31, 2023

(51) Int. Cl. B62D 33/02

(52) U.S. Cl. CPC B62D 33/0207

(57) ABSTRACT

A storage assembly for a vehicle including: a locking member that is supported by the vehicle; a rod that is configured for engagement with the locking member; and at least one retainer that is supported by the rod and which is configured to receive at least one article. The rod is rotatable in relation to the locking member such that the storage assembly is repositionable between a stowed position, in which the at least one retainer is generally concealed within a sidewall of the vehicle, and a loading position, in which the at least one retainer is exposed from the sidewall of the vehicle to facilitate insertion of the at least one article into the at least one retainer.

### TECHNICAL FIELD

The present disclosure relates to a storage system for use in storing articles in a vehicle.

### BACKGROUND

Vehicle storage systems are well known and are utilized to retain or otherwise secure tools, camping equipment, sports equipment, etc. Known vehicle storage systems, however, are often static (i.e., fixed in configuration) or offer limited repositionability.

The present disclosure addresses this shortcoming by providing a storage system that is movable in multiple degrees of freedom, which not only offers more robust stowage options, but enhances the securement of stowed articles.

### SUMMARY

In one aspect of the present disclosure, a storage assembly for a vehicle is disclosed. The storage assembly includes: a locking member that is supported by the vehicle; a rod that is configured for engagement with the locking member; and at least one retainer that is supported by the rod and which is configured to receive at least one article. The rod is rotatable in relation to the locking member such that the storage assembly is repositionable between a stowed position, in which the at least one retainer is generally concealed within a sidewall of the vehicle, and a loading position, in which the at least one retainer is exposed from the sidewall of the vehicle to facilitate insertion of the at least one article into the at least one retainer.

In certain embodiments, the rod may be axially repositionable in relation to the locking member along a length of the vehicle.

In certain embodiments, the rod may be repositionable between an advanced position, in which the rod is engaged with the locking member to thereby secure the storage assembly in either the stowed position or the loading position, and a retracted position, in which the rod is disengaged from the locking member to thereby permit repositioning of the storage assembly between the stowed position and the loading position.

In certain embodiments, the rod may include a tactile member extending outwardly therefrom that is configured for manual engagement by a user to facilitate repositioning of the rod.

In certain embodiments, the storage assembly may further comprise a biasing member acting upon the rod so as to bias the rod towards the advanced position.

In certain embodiments, the biasing member may be configured as a spring.

In certain embodiments, the locking member may define a first receptacle and a second receptacle that is rotationally offset from the first receptacle.

In certain embodiments, the first receptacle and the second receptacle may be rotationally offset by an angle that lies substantially within the range of approximately 30 degrees to approximately 60 degrees.

In certain embodiments, the rod may include a key member that is configured for insertion into the first receptacle to thereby secure the storage assembly in the stowed position and into the second receptacle to thereby secure the storage assembly in the loading position.

In certain embodiments, the at least one retainer may be movable in relation to the rod.

In another aspect of the present disclosure, a storage assembly for a vehicle is disclosed. The storage assembly includes: a locking member that is supported by the vehicle; a rod that is axially and rotatably movable in relation to the locking member; at least one retainer that is supported by the rod and which is configured to receive at least one article; and a biasing member. The rod is repositionable between: a first axial position, in which the rod engages the locking member; a second axial position, in which the rod is disengaged from the locking member; a first rotational position, in which the at least one retainer extends in a generally vertical orientation; and a second rotational position, in which the at least one retainer extends in a non-vertical orientation to facilitate insertion of the at least one article into the at least one retainer, wherein the biasing member acts upon the rod so as to bias the rod toward the first axial position.

In certain embodiments, the rod may include a key member that extends outwardly therefrom and which is configured for insertion into the locking member.

In certain embodiments, the locking member may define a first receptacle and a second receptacle.

In certain embodiments, the first receptacle may be configured to receive the key member and thereby secure the rod is in the first rotational position, and the second receptacle may be configured to receive the key member and thereby secure the rod in the second rotational position.

In certain embodiments, the first receptacle and the second receptacle may be offset by an angle that lies substantially within the range of approximately 30 degrees to approximately 60 degrees.

In certain embodiments, the at least one retainer may be configured for resilient deflection to facilitate insertion and removal of the at least one article.

In another aspect of the present disclosure, a method of storing at least one article in a vehicle is disclosed. The method includes: repositioning a rod from a first axial position into a second axial position to thereby remove a key member on the rod from a locking member supported by the vehicle; rotating the rod from a first rotational position into a second rotational position; repositioning the rod from the second axial position into the first axial position so as to insert the key member into the locking member and thereby secure the rod in the second rotational position; and inserting the at least one article into at least one retainer supported by the rod.

In certain embodiments, repositioning the rod from the first axial position into the second axial position may include overcoming a biasing force applied to the rod.

In certain embodiments, repositioning the rod from the first axial position into the second axial position may include removing the key member from a first receptacle defined by the locking member.

In certain embodiments, rotating the rod from the first rotational position into the second rotational position may include aligning the key member with a second receptacle defined by the locking member.

In certain embodiments, the method may further comprise repositioning the at least one retainer along the rod.

### BRIEF DESCRIPTION OF THE DRAWINGS

According to common practice, the various features of the drawings may not be to scale and may be arbitrarily expanded or reduced for clarity.

FIG. 1 is a partial, rear, perspective view of a vehicle including a storage system according to the principles of the present disclosure, which includes one or more individual storage assemblies, each of which includes: a locking member; a rod; and (one or more) at least one retainer that is configured to receive (one or more) at least one article.

FIG. 2A is a rear, plan view of the storage system shown in a stowed position.

FIG. 2B is a rear, plan view of the storage system shown in a loading position.

FIG. 3A is a rear, perspective view of one of the storage assemblies with the rod shown in a (first) advanced (axial) position and a first rotational position.

FIG. 3B is a rear, perspective view of the storage assembly seen in FIG. 3A with the rod shown in a (second) retracted (axial) position and the first rotational position.

FIG. 3C is a rear, perspective view of the storage assembly seen in FIG. 3A with the rod shown in the retracted position and a second rotational position.

FIG. 3D is a rear, perspective view of the storage assembly seen in FIG. 3A with the rod shown in the advanced position and the second rotational position.

### DETAILED DESCRIPTION

The present disclosure describes a storage system that is configured for use in storing (one or more) at least one article in a vehicle. The storage system includes one or more individual storage assemblies, each of which includes: a locking member; a rod that is movable in multiple degrees of freedom (e.g., in relation to the locking member); and (one or more) at least one retainer that is supported by the rod and which is configured to receive the article(s). More specifically, the rod is axially and rotatably repositionable in relation to the locking member, which facilitates engagement and disengagement of the rod and the locking member so as to allow for repositioning of the storage assembly between stowed and loading positions as well as securement of the storage assembly in the stowed and loading positions. When the storage assembly is in the stowed position, the retainer(s) are generally concealed within a sidewall of the vehicle, and when the storage assembly is in the loading position, the retainer(s) are exposed from the sidewall of the vehicle to facilitate insertion of the article(s) into the retainer(s).

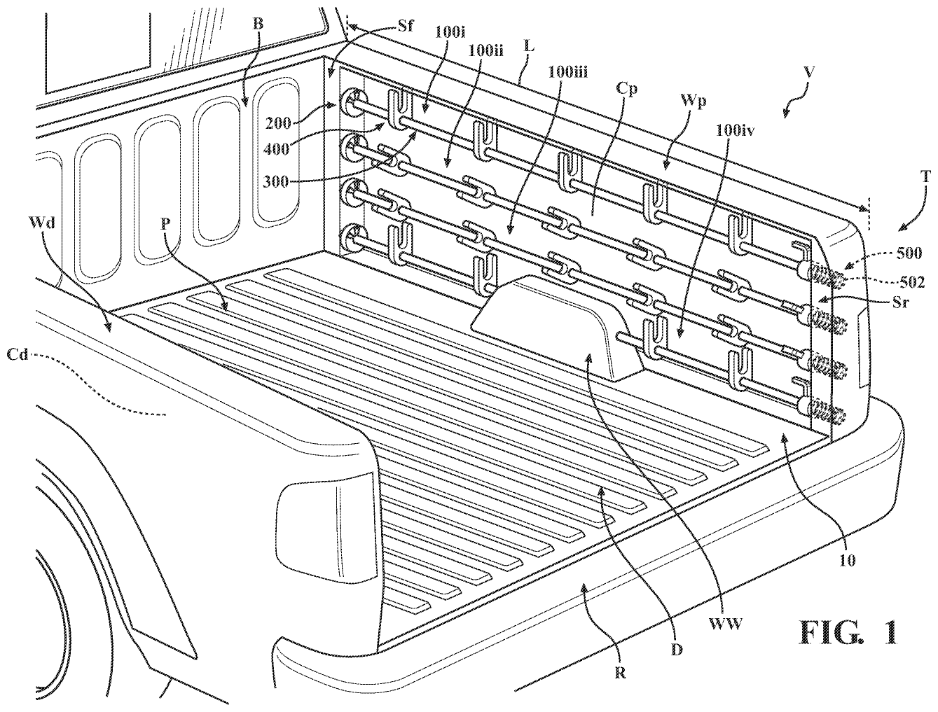

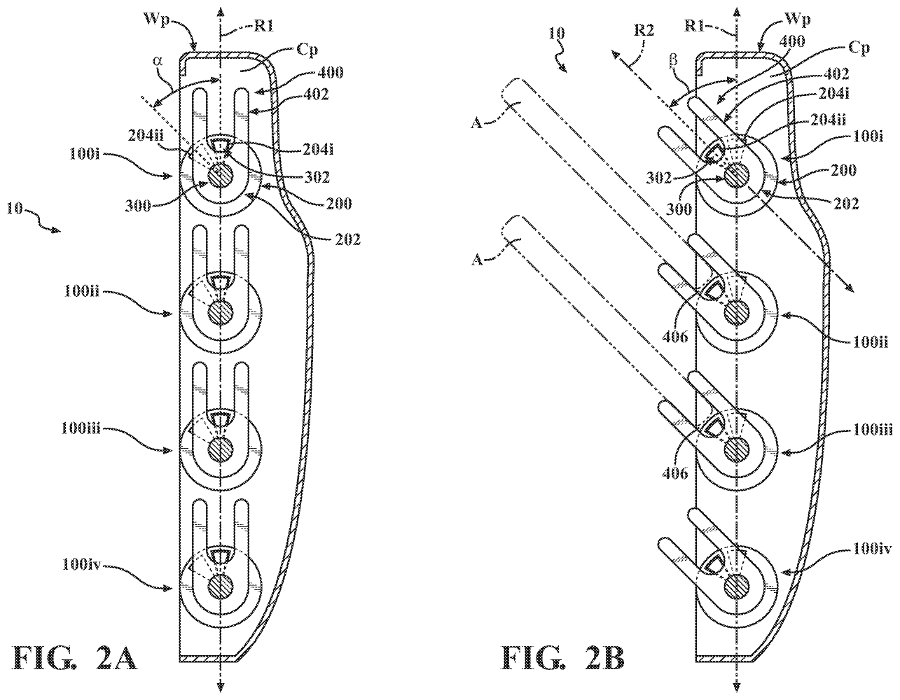

With reference to FIGS. 1-2B, a storage system 10 is disclosed that is configured for use in storing (one or more) at least one article A (FIG. 2B) in a vehicle V, such as, for example, camping or sports equipment (e.g., skis, snowboards, fishing poles, etc.), tools, and the like. Although generally illustrated and described in the context of a truck bed T, it should be appreciated that the storage system 10 described herein may be configured for installation in a wide variety of vehicles (e.g., trucks, SUVs, vans, buses, boats, airplanes, trains, etc.) in various locations (e.g., trunks, passenger compartments, etc.).

The truck bed T defines a cargo space P and includes: a bulkhead B; (first, forward and second, rear) strut towers Sf, Sr; (first, driver's side and second, passenger side) sidewalls Wd, Wp that extend between the strut towers Sf, Sr; a deck D; and wheel wells WW, which extend vertically upward into a cargo space P. Although shown as including an open rear end R, embodiments in which the truck bed T may include a tailgate are also envisioned herein and would not be beyond the scope of the present disclosure.

The storage system 10 includes (one or more) at least one storage assembly 100, which is mounted within an internal cavity Cp that is defined by the sidewall Wp. As described in detail below, each storage assembly 100 includes: a locking member 200; a rod 300; and (one or more) at least one retainer 400 (e.g., a clamp 402) that is configured to receive (one or more) at least one of the articles A in order to secure the article(s) A within the vehicle V and thereby protect both the article(s) A and the vehicle V from damage.

In the illustrated embodiment, the storage system 10 is shown as including four storage assemblies 100i-100iv that are exclusively associated with the sidewall Wp. Embodiments in which the storage system 10 may include greater or fewer numbers of storage assemblies 100 are also envisioned herein, however, as are embodiments in which the storage system 10 may include (one or more) at least one storage assembly 100 that is associated with the sidewall Wd, either in addition to or instead of the sidewall Wp, and would not be beyond the scope of the present disclosure.

The storage assemblies 100 are movable in multiple degrees of freedom. More specifically, as described in further detail below, the rods 300 are configured for both axial and rotational movement (i.e., in relation to the locking members 200), which facilitates independent repositioning of the storage assemblies 100 between a (first) stowed position (FIG. 2A) and a (second) loading position (FIG. 2B). In the stowed position, the retainers 400 are generally concealed by the sidewall Wp (i.e., within the internal cavity Cp) and are removed from the cargo space P, and in the loading position (FIG. 2B), the retainers 400 are exposed from the sidewall Wp (i.e., the internal cavity Cp) and extend into the cargo space P, which facilitates insertion of the article(s) A into the retainer(s) 400.

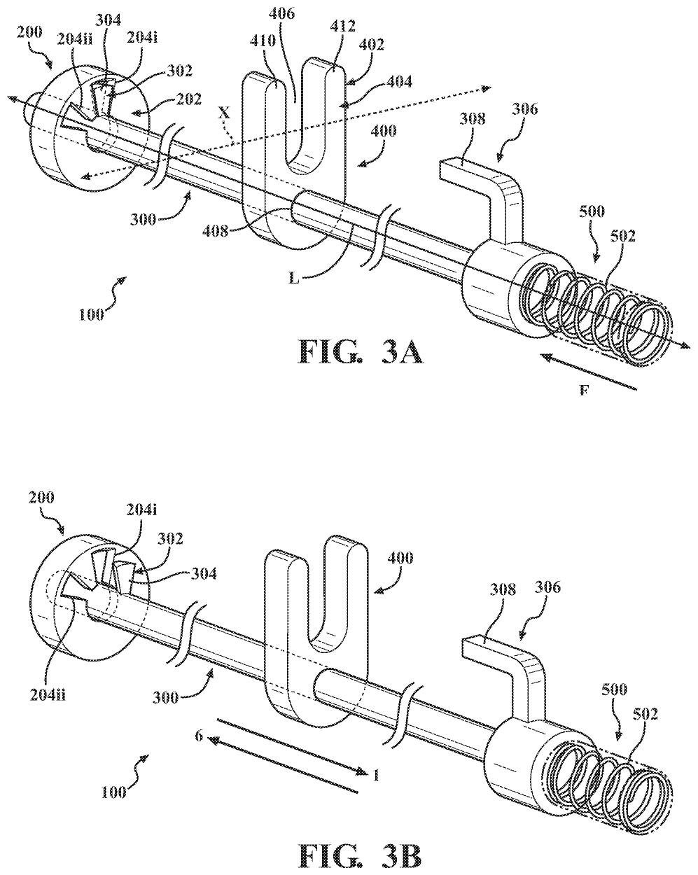

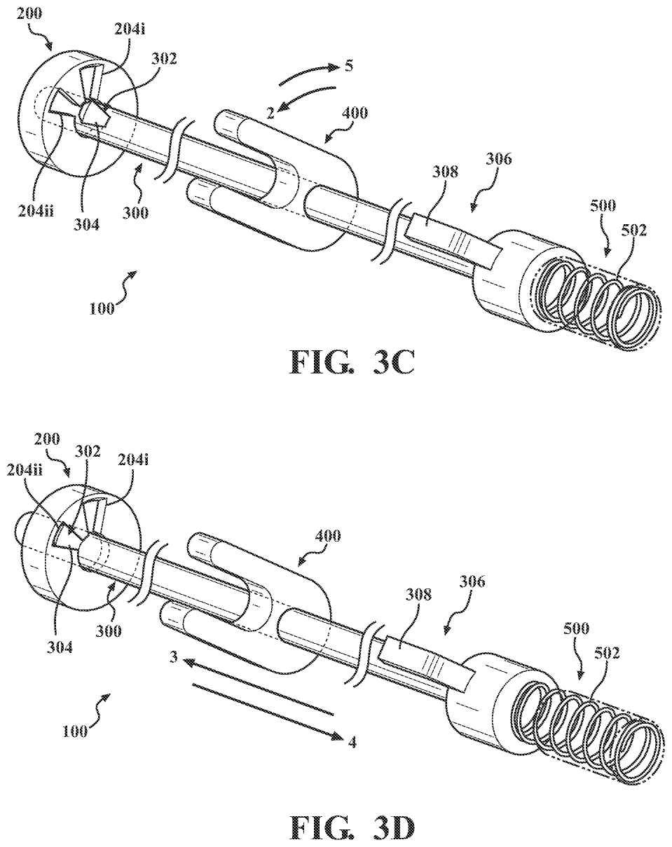

Referring to FIGS. 3A-3D as well, the locking members 200 are supported by the vehicle V (i.e., the truck bed T). More specifically, in the illustrated embodiment, the locking members 200 are supported by the strut tower Sf.

The locking members 200 include collars 202 that extend rearwardly from the strut tower Sf towards the strut tower Sr. The collars 202 define (first and second) receptacles 204i. 204ii, which are configured to receive the rods 300 when the storage assemblies 100 are in the stowed and loading positions, respectively. Embodiments of the storage assemblies 100 in which the receptacles 204i, 204ii may be formed directly in the strut tower Sf are also envisioned herein, however, which would allow for omission of the collars 202, as are embodiments in which the locking members 200 may include additional receptacles 204 (e.g., to allow for positioning of the storage assemblies 100 in a plurality of loading positions), and would not be beyond the scope of the present disclosure.

As seen in FIG. 2A, the receptacles 204i, 204ii are (rotationally, angularly) offset by an angle α that lies substantially within the range of approximately 30 degrees to approximately 60 degrees (e.g., approximately 45 degrees). Embodiments of the storage assemblies 100 in which the locking members 200 may be configured such that the angle α lies outside of the disclosed range are also envisioned herein (e.g., depending upon the particular configuration and/or style of the vehicle V), however, and would not be beyond the scope of the present disclosure.

The rods 300 extend between the strut towers Sf, Sr and are configured for removable (releasable) engagement with the locking members 200. More specifically, the rods 300 include (define) key members 302 (e.g., teeth 304) that extends radially outward therefrom and which are configured for removable insertion into the receptacles 204i, 204ii, as described in further detail below.

In the illustrated embodiment, the rods 300 are non-removably integrated into the vehicle V (i.e., the truck bed T). Embodiments in which the rods 300 may be configured for removable connection to the vehicle V are also envisioned herein, however, and would not be beyond the scope of the present disclosure.

The rods 300 are repositionable in relation to the locking members 200 (i.e., along a length L (FIG. 1) of the vehicle V) between a (first) advanced (axial) position (FIGS. 3A, 3D), in which the rods 300 engage the locking members 200 (i.e., such that the key members 302 are inserted into (positioned within)) the receptacle 204i or the receptacle 204ii to thereby secure the storage assembly 100 in the stowed position or the loading position, respectively), and a (second) retracted (axial) position (FIGS. 3B, 3C), in which the rods 300 are disengaged from the locking members 200 (i.e., such that the key members 302 are removed from the receptacles 204i, 204ii to thereby permit repositioning of the storage assembly 100 between the stowed and loading positions). Additionally, the rods 300 are rotatable in relation to the locking members 200 between a first rotational position (FIGS. 3A, 3B), in which the key members 302 are generally aligned with the receptacles 204i, and a second rotational position (FIGS. 3C, 3D), in which the key members 302 are generally aligned with the receptacles 204ii.

In certain embodiments, such as that illustrated throughout the figures, the storage assemblies 100 may further include biasing members 500 (e.g., coil springs 502) that act upon (e.g., engage, contact, interface with) the rods 300 so as to apply a biasing force F (FIG. 3A) thereto that biases the rods 300 towards the advanced position. Embodiments of the storage assemblies 100 that are devoid of the biasing members 500 are also envisioned herein, however, and would not be beyond the scope of the present disclosure. For example, embodiments are envisioned in which the rods 300 may be mechanically secured in the advanced position (e.g., via one or more fasteners, clips, straps, magnets, etc., via an interference fit with the locking members 200, or in any other suitable manner).

Although shown as being positioned between the rods 300 and the strut tower Sr, it is envisioned that the biasing members 500 may be positioned in any location and supported in any manner suitable for the intended purpose of biasing the rods 300 toward the advanced position. For example, embodiments in which the biasing members 500 may be positioned between the rods 300 and the strut tower Sf are also envisioned herein and would not be beyond the scope of the present disclosure.

As seen in FIG. 3A, when the rods 300 are in the advanced position and the first rotational position, the key members 302 are inserted into (are received by) the receptacles 204i, thereby securing the rods 300 in the first rotational position and, thus, securing the storage assemblies 100 in the stowed position (FIG. 2A). By contrast, as seen in FIG. 3D, when the rods 300 are in the advanced position and the second rotational position, the key members 302 are inserted into (are received by) the receptacles 204ii, thereby securing the rods 300 in the second rotational position and, thus, securing the storage assemblies 100 in the loading position (FIG. 2B).

In order to facilitate repositioning of the rods 300 between the advanced and retracted positions and/or between the first and second rotational positions, in certain embodiments, such as that illustrated throughout the figures, the storage assemblies 100 (e.g., the rods 300) may further include tactile members 306 (e.g., handles 308) that extend radially outward therefrom and which are configured for manual engagement by a user.

With reference to FIG. 3A in particular, the retainers 400 include body portions 404 that define receiving spaces 406, which are configured to receive the article(s) A, and apertures 408, which are configured to receive the rods 300 such that the rods 300 extend through the retainers 400 via the apertures 408. More specifically, the body portions 404 are forked (e.g., generally U-shaped) in configuration and include arms 410, 412, which are separated along an axis X that extends in generally orthogonal (perpendicular) relation to the rods 300 (and the length L of the vehicle V).

The retainers 400 are supported by the rods 300 such that axial and rotational repositioning of the rods 300 causes corresponding axial and rotational repositioning of the retainers 400. More specifically, when the storage assembly 100 is in the stowed position (FIG. 2A) (i.e., when the rods 300 are in the first rotational position), the retainers 400 extend in a generally vertical orientation (i.e., in generally parallel relation to a vertical reference axis R1), and when the storage assembly 100 is in the loading position (FIG. 2B) (i.e., when the rods 300 are in the second rotational position), the retainers 400 extend in a non-vertical orientation along an axis R2 that is oriented at an angle β in relation to the reference axis R1. The angle β is dictated by and corresponds (i.e., is approximately equal) to the angle α (FIG. 2A) (i.e., the offset between the receptacles 204i, 204ii) and facilitates insertion of the article(s) A into the retainer(s) 400 (i.e., the receiving spaces 406).

In certain embodiments, it is envisioned that the retainers 400 may be configured for resilient deflection in order to facilitate insertion and removal of the article(s) A, whereby the article(s) A are frictionally received by the retainers 400 (i.e., with the receiving spaces 406). For example, it is envisioned that the retainer(s) 400 may include (i.e., may be formed partially or entirely from) one or more resilient materials (e.g., plastic(s), polymeric material(s), etc.). Additionally, or alternatively, it is envisioned that the retainers 400 may include a lock and release mechanism (or other such structure, component, or features) in order to secure the article(s) A within the receiving spaces 406.

In the illustrated embodiment, the rods 300 and the retainers 400 are configured as separate, discrete components of the storage assemblies 100 that are configured for relative movement therebetween. More specifically, the rods 300 and the retainers 400 are configured so as to permit movement of the retainers 400 in relation to the rods 300 (i.e., axial repositioning of the retainers 400 along the length L of the vehicle V and/or rotational repositioning of the retainers 400) in order to better accommodate insertion of the article(s) A and/or a wider variety of article(s) A. Embodiments in which the retainers 400 may be fixed in relation to the rods 300 are also envisioned herein, however. For example, the present disclosure envisions embodiments in which the retainers 400 may be mechanically secured to the rods 300 via one or more fasteners (e.g., screw, pins, clips, etc.) as well as embodiments in which the retainers 400 and the rods 300 may be integrally (monolithically, unitarily) formed (i.e., from a single piece of material).

While each of the storage assemblies 100 is shown as including a plurality of retainers 400, embodiments in which the storage assemblies 100 may include a single retainer 400 are also envisioned herein and would not be beyond the scope of the disclosure. In such embodiments, it is envisioned that the dimensions of the (single) retainer 400 may be increased and/or that the specific material(s) of construction may be chosen so as to increase the overall strength of the (single) retainer 400.

In the illustrated embodiment of the storage system 10, the locking members 200 and the biasing members 500 are respectively associated with the strut towers Sf, Sr. Embodiments in which the configuration of the storage system 10 may be reversed (e.g., such that the locking members 200 and the biasing members 500 are respectively associated with the strut towers Sr. Sf) are also envisioned herein, however, and would not be beyond the scope of the present disclosure.

With continued reference to FIGS. 1-3D, a method of storing one or more of the article(s) A in the vehicle V using the storage system 10 will be discussed. While the following method is discussed in the context of multiple articles A that are stored using multiple storage assemblies A, it should be appreciated that following discussion is equally applicable to the storage of a single article A and/or to the use of a single storage assembly 100.

Initially, the storage assemblies 100 are moved from the stowed position (FIG. 2A) into the loading position (FIG. 2B), which includes: axially repositioning the rods 300 from the first axial position (FIG. 3A) into the second axial position (FIG. 3B) (e.g., via the tactile members 306) in the direction identified by the arrow 1 (FIG. 3B), which overcomes (and increases) the biasing force F (FIG. 3A) applied to the rods 300 by the biasing members 500 via compression thereof and removes the key members 302 from the receptacles 204i; rotating the rods 300 from the first rotational position (FIGS. 2A, 3A, 3B) into the second rotational position (FIGS. 2B, 3C, 3D) in the direction identified by the arrow 2 (FIG. 3C) to thereby generally align the key members 302 with the receptacles 204ii; and axially repositioning the rods 300 from the second axial position (FIG. 3C) into the first axial position (FIG. 3D) in the direction identified by the arrow 3 (FIG. 3D), whereby the key members 302 are inserted into the receptacles 204ii so as to secure the rods 300 in the second rotational position and secure the storage assemblies 100 in the loading position. In the illustrated embodiment, axially repositioning the rods 300 from the second axial position into the first axial position occurs automatically under the influence of the biasing force F (e.g., upon release of the tactile members 306).

With the storage assemblies 100 in the loading position, the articles A (FIG. 2B) can be inserted into the retainers 400 (i.e., the receiving spaces 406). Depending on the size and/or the configuration of the articles A, in order to better accommodate insertion of the articles A, the retainers 400 may be axially (and/or rotationally) repositioned in relation to the rods 300.

As seen in FIG. 1, the wheel wells WW extend laterally beyond the storage system 10 (i.e., inwardly into the cargo space P), which protects the storage system 10 and the articles A from additional items in the vehicle V (i.e., the truck bed T) and vice versa. In certain embodiments, it is envisioned that the storage system 10 may also be utilized to secure such additional items (e.g., by connecting straps, cords, rope, etc., to the rods 300).

With the articles A inserted into the retainers 400, again depending on the size and/or the configuration of the articles A as well as the configuration of the vehicle V (i.e., the truck bed T) and the (vertical) spacing between the storage assemblies 100, it is envisioned that the storage assemblies 100 may remain in the loading position. Alternatively, it is envisioned that one or more of the storage assemblies 100 may be moved from the loading position into the stowed position, which includes: axially repositioning the rods 300 from the first axial position (FIG. 3D) into the second axial position (FIG. 3C) in the direction identified by the arrow 4 (FIG. 3D), which removes the key members 302 from the receptacles 204ii; rotating the rods 300 from the second rotational position (FIGS. 2B, 3C, 3D) into the first rotational position (FIGS. 2A, 3A, 3B) in the direction identified by the arrow 5 (FIG. 3C) to thereby generally align the key members 302 with the receptacles 204i; and axially repositioning the rods 300 from the second axial position (FIG. 3B) into the first axial position (FIG. 3A) in the direction identified by the arrow 6 (FIG. 3B) (i.e., under the influence of the biasing force F (FIG. 3A), whereby the key members 302 are inserted into the receptacles 204i so as to secure the rods 300 in the first rotational position and secure the storage assemblies 100 in the stowed position.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises.” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above.” “below,” “upper,” “lower,” “inner,” “outer,” “left.” “right.” “upward.” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°+25% (i.e., an angle that lies within the range of (approximately) 135° to (approximately)) 225° and the term “generally orthogonal” should be understood as referring to configurations in with the pertinent components are oriented so as to define an angle therebetween that is equal to 90°+25% (i.e., an angle that lies within the range of (approximately) 67.5° to (approximately)) 112.5°. The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A storage assembly for a vehicle, the storage assembly comprising:
a locking member supported by the vehicle;
a rod configured for engagement with the locking member; and
at least one retainer supported by the rod and configured to receive at least one article, wherein the rod is rotatable in relation to the locking member such that the storage assembly is repositionable between a stowed position, in which the at least one retainer is generally concealed within a sidewall of the vehicle, and a loading position, in which the at least one retainer is exposed from the sidewall of the vehicle to facilitate insertion of the at least one article into the at least one retainer.

2. The storage assembly of claim 1, wherein the rod is axially repositionable in relation to the locking member along a length of the vehicle.

3. The storage assembly of claim 2, wherein the rod is repositionable between an advanced position, in which the rod is engaged with the locking member to thereby secure the storage assembly in either the stowed position or the loading position, and a retracted position, in which the rod is disengaged from the locking member to thereby permit repositioning of the storage assembly between the stowed position and the loading position.

4. The storage assembly of claim 3, wherein the rod includes a tactile member extending outwardly therefrom and configured for manual engagement by a user to facilitate repositioning of the rod.

5. The storage assembly of claim 3, wherein the storage assembly further comprises:
a biasing member acting upon the rod so as to bias the rod towards the advanced position.

6. The storage assembly of claim 5, wherein the biasing member is configured as a spring.

7. The storage assembly of claim 3, wherein the locking member defines a first receptacle and a second receptacle rotationally offset from the first receptacle.

8. The storage assembly of claim 7, wherein the first receptacle and the second receptacle are rotationally offset by an angle that lies substantially within a range of approximately 30 degrees to approximately 60 degrees.

9. The storage assembly of claim 7, wherein the rod includes a key member configured for insertion into the first receptacle to thereby secure the storage assembly in the stowed position and into the second receptacle to thereby secure the storage assembly in the loading position.

10. The storage assembly of claim 1, wherein the at least one retainer is movable in relation to the rod.

11. A storage assembly for a vehicle, the storage assembly comprising:
a locking member supported by the vehicle;
a rod axially and rotatably movable in relation to the locking member;
at least one retainer supported by the rod and configured to receive at least one article, wherein the rod is repositionable between:
a first axial position, in which the rod engages the locking member;
a second axial position, in which the rod is disengaged from the locking member;
a first rotational position, in which the at least one retainer extends in a generally vertical orientation; and
a second rotational position, in which the at least one retainer extends in a non-vertical orientation to facilitate insertion of the at least one article into the at least one retainer; and
a biasing member acting upon the rod so as to bias the rod toward the first axial position.

12. The storage assembly of claim 11, wherein the rod includes a key member extending outwardly therefrom and configured for insertion into the locking member.

13. The storage assembly of claim 12, wherein the locking member defines a first receptacle configured to receive the key member and thereby secure the rod is in the first rotational position and a second receptacle configured to receive the key member and thereby secure the rod in the second rotational position.

14. The storage assembly of claim 13, wherein the first receptacle and the second receptacle are offset by an angle that lies substantially within a range of approximately 30 degrees to approximately 60 degrees.

15. The storage assembly of claim 11, wherein the at least one retainer is configured for resilient deflection to facilitate insertion and removal of the at least one article.

16. A method of storing at least one article in a vehicle, the method comprising:
repositioning a rod from a first axial position into a second axial position to thereby remove a key member on the rod from a locking member supported by the vehicle;
rotating the rod from a first rotational position into a second rotational position;
repositioning the rod from the second axial position into the first axial position so as to insert the key member into the locking member and thereby secure the rod in the second rotational position; and
inserting the at least one article into at least one retainer supported by the rod.

17. The method of claim 16, wherein repositioning the rod from the first axial position into the second axial position includes overcoming a biasing force applied to the rod.

18. The method of claim 16, wherein repositioning the rod from the first axial position into the second axial position includes removing the key member from a first receptacle defined by the locking member.

19. The method of claim 18, wherein rotating the rod from the first rotational position into the second rotational position includes aligning the key member with a second receptacle defined by the locking member.

20. The method of claim 16, further comprising:
repositioning the at least one retainer along the rod.
